(19) United States
(12) Patent Application Publication
(10) Pub. No.: US 2006/0277331 A1
(43) Pub. Date: Dec. 7, 2006

(54) Communication using bit replication

(76) Inventors: Anthony L. Priborsky, Lyons, CO (US); Michelle E. Blankenship, Longmont, CO (US); Jonathan Damron, Boulder, CO (US)

Correspondence Address: H. Sanders Gwin, Jr.;Shumaker & Sieffert, P.A., Suite 105, 8425 Seasons Parkway, St. Paul, MN, 55125, US

(21) Appl. No.: 11/132,087

(22) Filed: May 18, 2005

(51) Int. Cl. G06F 3/00

(52) U.S. Cl. 710/60

(57) ABSTRACT

A method of transmitting data over a serial communications interface may include transmitting, from a first device to a second device, a first sequence of bits over the serial communications interface at a first transmission rate. A second sequence of bits may be received by the first device. A third sequence of bits may be generated from the second sequence of bits. The third sequence of bits may include each bit in the second sequence of bits repeated a predetermined number of times but otherwise arranged in the same order as in the second sequence of bits. When the third sequence of bits is transmitted over the serial communication interface at the first transmission rate, the effective transmission rate of the third sequence of bits may be a function of the predetermined number of times each bit is repeated.

### TECHNICAL FIELD

This disclosure relates to replicating bits in a communication interface.

### BACKGROUND

One device may exchange data with another device through a variety of methods. For example, a parallel communication interface may allow a first device to transmit data to a second device by simultaneously sending a plurality of bits over several wires, or channels, to the second device, along with a clock signal to demarcate bit boundaries. A serial interface may provide another method for a first device to communicate with a second device. A serial communication interface may allow a first device to transmit data to a second device by sending a plurality of bits, serially (a bitstream). Some serial communication protocols allow two or more devices to exchange data without sharing a separate clock signal. Such serial interfaces may utilize a particular bit encoding, such as Manchester encoding or 8B/10B encoding. The encoding may assure that the bitstream includes enough bit transitions to permit a receiving device to recover from the bitstream a clock signal to use in demarcating bit boundaries in the bitstream.

### SUMMARY

A communication interface may include a bit-replicating means to selectively alter an effective communication rate. In some embodiments, the communication interface may include a high-speed channel that transmits and receives a serial bitstream at a first communication rate. The communication interface may further include a signaling channel that transmits and receives a serial bitstream at a second, lower communication rate. By replicating bits and transmitting them at the first communication rate, the effective communication rate of the transmitted bits may accommodate the second communication rate of the signaling channel.

In some embodiments, a method of transmitting data over a serial communications interface includes transmitting, from a first device to a second device, a first sequence of bits over the serial communications interface at a first transmission rate. A second sequence of bits may be received by the first device. A third sequence of bits may be generated from the second sequence of bits. The third sequence of bits may include each bit in the second sequence of bits repeated a predetermined number of times but otherwise arranged in the same order as in the second sequence of bits. When the third sequence of bits is transmitted over the serial communication interface at the first transmission rate, the effective transmission rate of the third sequence of bits may be a function of the predetermined number of times each bit is repeated. The third sequence of bits may be transmitted from the first device to the second device over the serial communications interface at the first transmission rate.

Certain embodiments may have one or more advantages. For example, a single integrated circuit may efficiently implement the method, thereby minimizing incremental cost and physical size. The method may be performed at any integral fraction of a normal data rate. The method may allow the third sequence of bits to be transmitted at a plurality of different effective rates.

Various embodiments may be implemented using a system, a method, or a computer program, or any combination of systems, methods and computer programs. The details of one or more embodiments are set forth in the accompanying drawings and the description below. Other features, objects and advantages will be apparent from the description and drawings, and from the claims.

### DESCRIPTION OF DRAWINGS

FIG. 1 is a block diagram of an exemplary computer system in which bits may be replicated.

FIG. 2 is a block diagram showing additional details of an exemplary host bus adapter and an exemplary storage device.

FIG. 3 is a block diagram showing additional details of the exemplary bus adapter.

FIG. 4 is a first waveform diagram of exemplary differential data that may be transmitted by a Serial ATA (SATA) transmitter or received by a SATA receiver.

FIG. 5A is a second waveform diagram of exemplary differential data that may be transmitted by the SATA transmitter or received by the SATA receiver.

FIG. 5B shows two exemplary out-of-band (OOB) signaling waveforms that may be used to communicate specific SATA commands.

FIG. 6 is a block diagram showing additional details of an exemplary transmit block.

FIG. 7A and FIG. 7B are flow diagrams showing how the exemplary transmit block may manipulate bits.

FIG. 8 shows additional details of an exemplary register block.

FIG. 9 shows additional details of an exemplary bit replicator.

FIG. 10 shows additional details of an exemplary serializer.

Like reference symbols in the various drawings indicate like elements.

### DETAILED DESCRIPTION OF EXEMPLARY EMBODIMENTS

By replicating bits and transmitting them at a first communication rate, the effective communication rate of the transmitted bits may accommodate a second communication rate. A serial communications interface may support multiple communication channels. One channel may permit high-speed communication between devices once the channel has been configured in a way that allows the two devices to operate in a synchronized manner. Another channel, for example a signaling channel, may permit devices to communicate before a high-speed channel is configured.

An exemplary serial communication interface may be characterized by the Serial ATA: High Speed Serialized AT Attachment, Revision 1.0a specification, and the Serial ATA II: Electrical Specification, Revision 1.0. Both of these specifications (hereafter, the “SATA specifications”) are publicly available at http://www.sata-io.org.

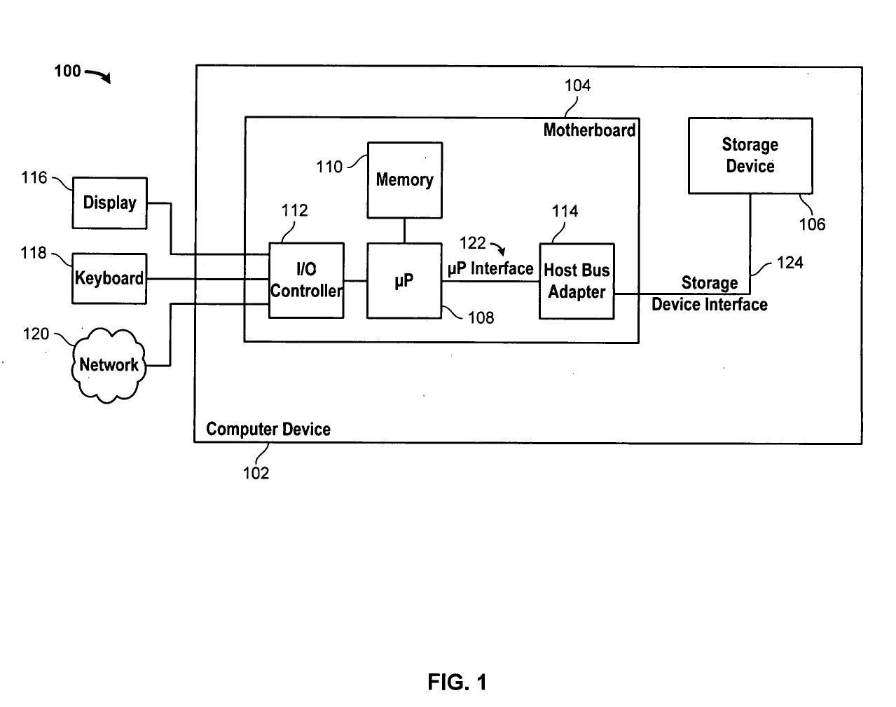

FIG. 1 is a block diagram of an exemplary embodiment of a computer system 100 in which bits may be replicated. The computer system 100 includes a computer device 102 comprising a motherboard 104 and a storage device 106. The motherboard 104 includes a microprocessor (μP) 108, memory 110, an I/O controller 112, and a host bus adapter 114. The I/O controller 112 allows the computer device 102 to interface external input/output devices, such as a display 116, a keyboard 118, or a network 120. The microprocessor 108 is operatively coupled to the host bus adapter 114 through a microprocessor interface 122. Additional interfaces (not shown) may be interposed between the host bus adapter 114 and the microprocessor 108. For example, a memory controller (not shown) may connect directly to the microprocessor and provide a bridge function to the host bus adapter 114. Moreover, the host bus adapter 114 may be included in an industry standard architecture (ISA) card. The host bus adapter 114 is operatively coupled to the storage device 106 through a storage device interface 124, such as, for example, a Serial Advanced Technology Attachment (SATA) interface. Other configurations are possible. For example, the host bus adapter 114 may couple the microprocessor 108 to more than one storage device.

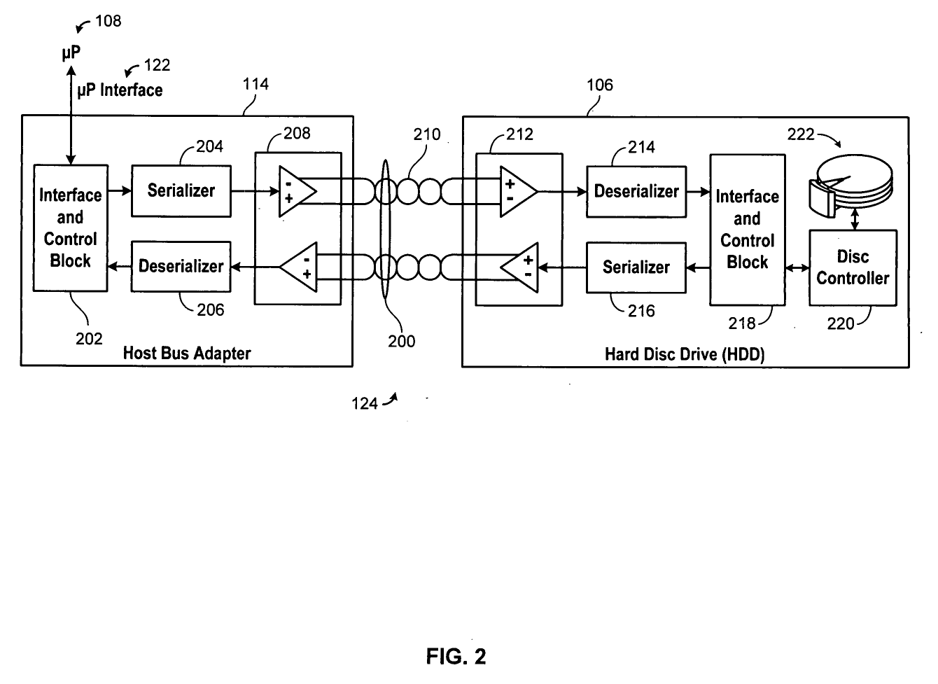

FIG. 2 is a block diagram showing exemplary embodiments of the host bus adapter 114, the storage device 106 and the storage device interface 124 that are shown in FIG. 1. As shown in FIG. 2, an exemplary storage device 106 is a hard disc drive (HDD) having a SATA interface 200. The exemplary host bus adapter 114 includes a interface and control block 202, a serializer 204, a deserializer 206, and a physical interface 208. The interface and control block 202 receives data and commands from the microprocessor 108 over the microprocessor interface 122. Data is serialized by the serializer 204 and transmitted over a twisted pair of wires 210, by the physical interface 208, to the HDD 106.

The host bus adapter 114 could comprise a series of discrete components, or it could be a single device. For example, a system-on-a-chip (SoC) design may include the aforementioned discrete blocks in a single device. The host bus adapter 114 could also be incorporated into the microprocessor 108 itself. Further, although the exemplary embodiment comprises a twisted pair of wires 210 coupling the host bus adapter 114 and the HDD 106, the host bus adapter 114 and the HDD 106 could be coupled in other ways. For example, the twisted pair of wires 210 could be replaced with traces on a printed circuit board and connectors in a backplane environment.

Like the host bus adapter 114, the HDD 106 also includes a physical interface 212, a deserializer 214, and a serializer 216. In addition, the HDD 106 includes an interface and control block 218, a disc controller 220 and physical storage media 222. The physical interface 212 receives data from the host bus adapter 114, which the deserializer 214 deserializes. After being deserialized, the data is processed by the interface and control block 218 and the disc controller 220.

The data may comprise, for example, a read or write command. In the case of a read command, the data causes the disc controller to retrieve data from a particular region of the physical media 222. The retrieved data is then serialized (216) and transmitted by the physical interface 212 to the host bus adapter 114. The host bus adapter 114 receives the retrieved read data from the SATA interface 200 through its physical interface 208. It deserializes (206) the data and provides it to the interface and control block 202, from which the microprocessor 108 can retrieve it.

The various components described may be discrete components, or they may be included within a single device. For example, an application specific integrated circuit (ASIC) may include the components 212, 214, 216, 218 and 220. Another ASIC may include the components 202, 204, 206 and 208.

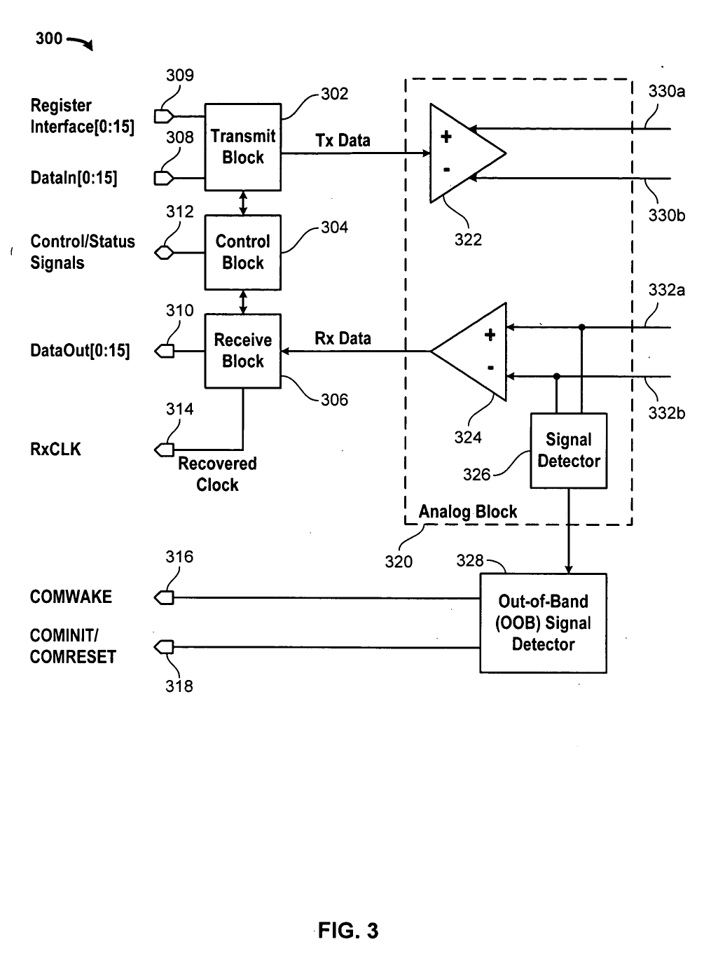

FIG. 3 is a block diagram showing additional details of an exemplary bus adapter 300, such as the host bus adapter 114 or components 212, 214, 216 and parts of 218 and 220 in the HDD 106. The exemplary bus adapter 300 includes a transmit block 302; a control block 304; a receive block 306; data ports 308 and 310; a register interface 309; control and status signals 312, 316 and 318; a recovered clock signal 314; an analog block 320; and an out-of-band (OOB) signal detector 328.

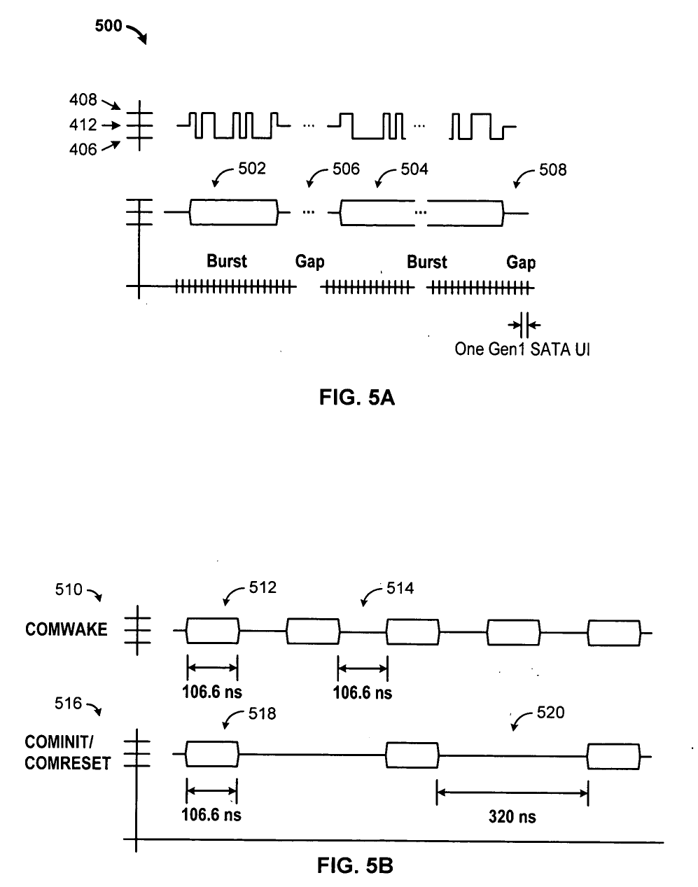

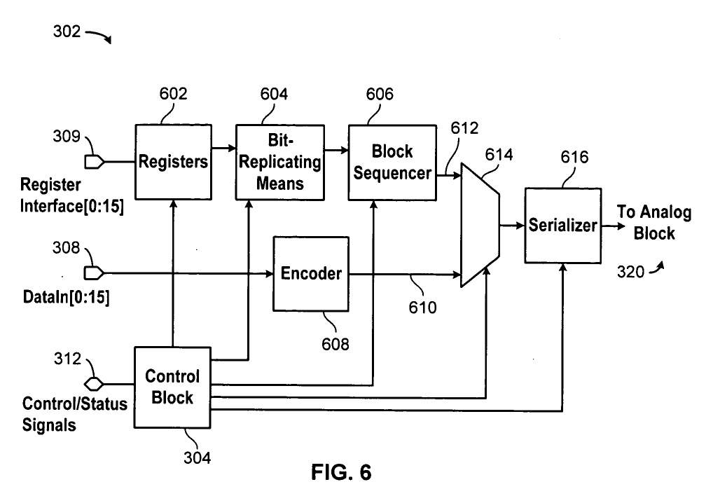

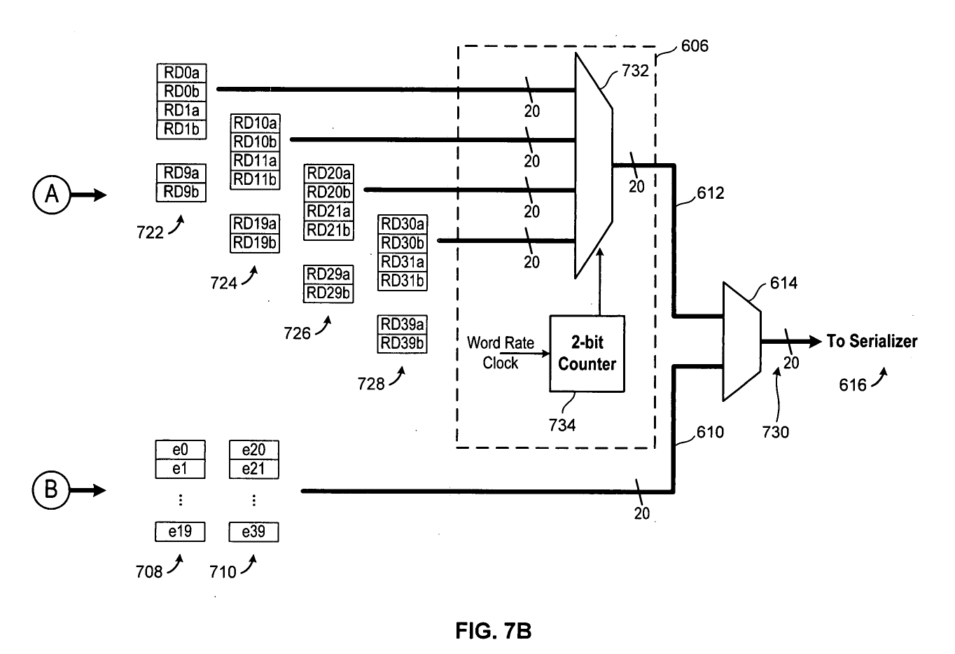

The analog block 320 includes a differential transmitter 322, a differential receiver 324, and a signal detector 326. The differential transmitter 322 may comprise, for example, a digital-to-analog interface. Similarly, the differential receiver 324 may comprise an analog-to-digital interface. To transmit data, the bus adapter 300 receives data through the data port 308, encodes and serializes the data in the transmit block 302, and transmits it serially through the differential transmitter 322 over lines 330a and 330b. Similarly, the bus adapter 300, via the differential receiver 324, receives differential data sent over lines 332a and 332b, deserializes and decodes the data in the receive block 306, and presents the data at the data port 310. Other data, for example out-of-band (OOB) signaling data, may be transmitted through a register interface 309, as will be further described with reference to FIG. 5B and FIG. 7.

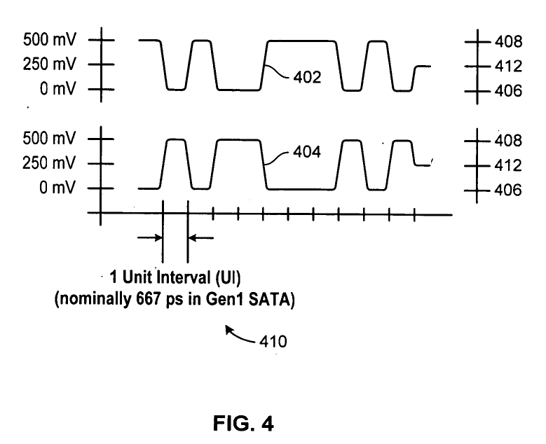

Differential data received from lines 332a and 332b may be filtered and analyzed to detect OOB signaling. A signal detector 326 initially filters incoming data to detect a signal. Detected signals are then passed to the OOB signal detector 328. Functionality of the OOB signal detector 328 is described below, with reference to the waveform diagrams that are shown in FIG. 4 and FIG. 5.

FIG. 4 shows a waveform diagram of exemplary differential data that may be transmitted by the transmitter 322 or received by the receiver 324 that are shown in FIG. 3. In FIG. 4, a vertical axis represents voltage and a horizontal axis represents time. Waveform 402 represents a time-varying voltage that may appear on the positive transmit line 330a or on the positive receive line 332a. Waveform 404 represents a corresponding time-varying voltage that would simultaneously appear on the negative transmit line 330b or on the negative receive line 332b. The voltage of each waveform 402 and 404 varies from a low voltage 406 to a high voltage 408 to, when taken together, represent digital values. Waveform 404 is a mirror image of waveform 402; that is, when the voltage represented by waveform 402 is equal to the high voltage 408, the voltage represented by waveform 404 is equal to the low voltage 406. One bit of digital data may be transmitted or received in a unit interval (UI) 410 period of time. In Gen1 SATA, one UI is nominally equal to 667 picoseconds (ps). At certain times, the lines 330a, 330b, 332a and 332b may be maintained at a common mode voltage level, represented pictorially by the level 412.

FIG 5A shows exemplary representations 500 of a waveform similar to the waveform 402 that is shown in FIG. 4 but with a different time scale. Periods of OOB signal activity during which predetermined patterns of bit transitions are transmitted or received are represented by “bursts” 502 and 504. Quiescent periods, during which no digital data are transmitted or received, are represented by “gaps” 506 and 508. During the gaps, the voltages of the positive lines 330a, and 332a and the negative lines 330b, and 332b are at the common mode voltage level 412. Bursts and gaps may be used to establish high-speed communication. Once a high-speed communication link is established, bits may be continuously transmitted, and gaps may be absent.

FIG. 5B shows the relative timing between the bursts and gaps that are shown in FIG. 5A for three exemplary OOB waveforms used to establish high-speed communication. The SATA specifications characterize three OOB signals: COMWAKE, COMINIT and COMRESET. Waveform 510 represents a COMWAKE signal. Each burst 512 in the COMWAKE signal has a nominal duration of 106.6 nanoseconds (ns), or 160 Gen1 UIs. Each gap 514 also has a nominal duration of 106.6 ns, or 160 Gen1 UIs. Waveform 516 represents either a COMINIT or a COMRESET signal, depending on whether the host or storage device transmitted the signal. A host, such as the host bus adapter 114, transmits the COMRESET signal; a device, such as the HDD 106, responds with the COMINIT signal. Bursts 518 in a COMINIT or COMRESET signal have a nominal duration of 106.6 ns, or 160 Gen1 UIs; gaps 520 in a COMINIT or COMRESET signal have a nominal duration of 320 ns, or 480 Gen1 UIs.

Referring back to FIG. 3, the OOB signal detector 328 in the exemplary bus adapter 114 identifies the OOB COMWAKE, COMINIT or COMRESET signals based on patterns of bursts and gaps. The OOB signal detector 328 distinguishes bursts from gaps and identifies bitstreams as OOB signals when the durations meet the burst and gap patterns characterized by the SATA specifications. Maintenance of the lines 332a and 332b at a common-mode voltage level during gaps may make the bus adapter more susceptible to electrical noise from the environment. As a result, particularly in a Gen2 SATA system, where a UI is nominally only 333 ps, OOB signals may be more accurately identified when they are bit-doubled and transmitted at a Gen2 bit rate, yielding an effective Gen1 bit rate.

To facilitate both high-speed data communication at the Gen2 rate of 3.0 Gbps and OOB signal communication at the Gen1 rate of 1.5 Gbps, it may be advantageous for a transmit block to be able to transmit data at multiple rates. Rather than physically transmitting bits at different rates, a transmit block may transmit data at a slower effective rate by transmitting each bit more than one time. For example, if a serial transmitter transmits each bit twice, the receiver receives the serial bitstream at an effective rate that is one-half the native rate of the transmitter.

For purposes of illustration, this disclosure describes bit doubling; however, the disclosure is not limited to methods and systems that replicate bits twice. Bits may be advantageously replicated any number of times. For example, a SATA system may transmit data at 6.0 Gbps while still requiring OOB signals to be transmitted at 1.5 Gbps. In such a system, a single transmit block may transmit both data and OOB signals by transmitting OOB signal bits at 6.0 Gbps but replicating each bit four times. The operation of an exemplary transmit block will be more fully appreciated with reference to the remaining figures.

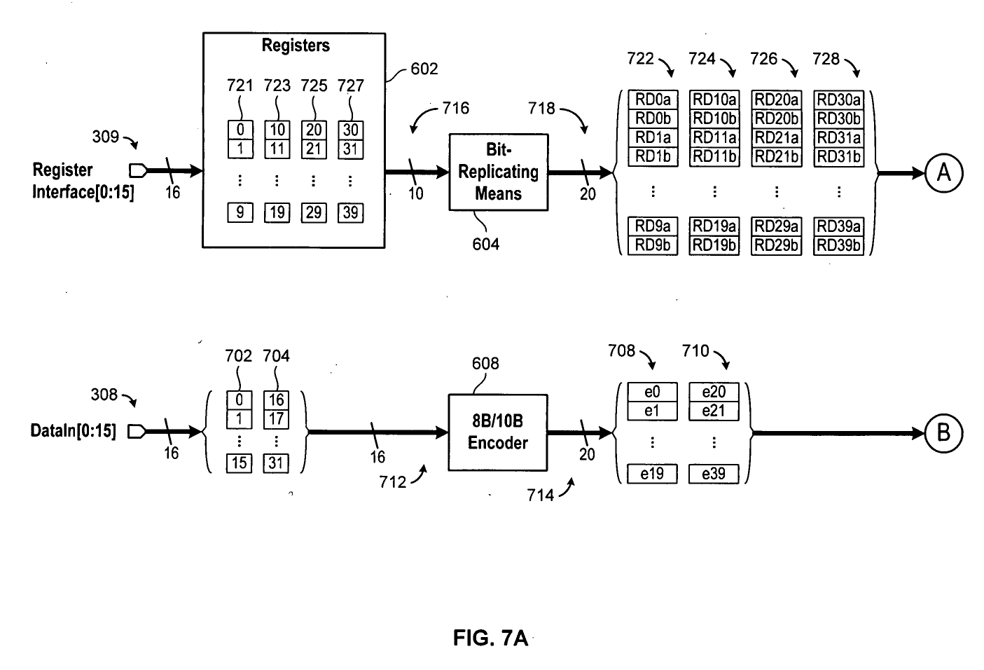

FIG. 6 is a block diagram showing additional details of the exemplary transmit block 302 that is shown in FIG. 3. Data that is not to be bit-replicated enters the transmit block 302 through the data port 308, and the data is encoded by an encoder 608. For example, the data could be encoded in 8B/10B format, wherein each byte is encoded in 10 bits that comprise particular bit sequences. Data that is to be bit-replicated, such as, for example, OOB signaling data, enters the transmit block 302 through the register interface 309, and registers 602 capture the incoming data. Individual bits in the data are replicated by a bit-replicating means 604, and blocks of replicated bits are sent to a block sequencer 606. The output 610 of the encoder or the output 612 of the block sequencer 606 are selected by a selector 614 and sent to a serializer 616. The serializer 616 sends a serialized bitstream to the analog block 320. The control block 304 controls the overall operation of the registers 602, the bit-replicating means 604, the block sequencer 606, the selector 614, and the serializer 616.

FIGS. 7A and 7B are block diagrams showing how, in exemplary embodiments, bits may be manipulated by the transmit block 302 that is shown in FIG. 3 and FIG. 6. Data from the data port 308 is encoded by the encoder 608. In an exemplary SATA system, the encoder 608 encodes each byte of data to 10 encoded bits in an 8B/10B format. For example, a first two-byte block of data 702 may be encoded to a first 20-bit block of bits 708, and a second two-byte block of data 704 may be encoded to a second 20-bit block of bits 710. The 10-bit encoding may ensure that the each block of bits comprises particular bit sequences and a minimum number of bit transitions. In some embodiments (not shown), the data may be initially captured by registers, latches or other storage components. In some embodiments, an input 712 and output 714 of the encoder 608 may be different widths. For example, the encoder 608 may input one byte of data in sequence and may output 10 bits of 8B/10B encoded data.

OOB signal data from the register interface 309 is captured by the registers 602. As shown, the registers 602 may comprise four ten-bit registers 721, 723, 725 and 727. In other embodiments, the registers 602 could include three 16 bit registers, or other practical configurations. The registers could be shift registers, latches or other components configured to capture bits from the register interface 309. Although the register interface 309 is shown to be 16 bits wide, it could be any width. For example, the register interface 309 could have an 8-bit width, a 32-bit width, a 64-bit width, or any other practical width.

As shown, the registers 721, 723, 725 and 727 are configured to be loaded by several write operations. For example, a first write to the registers 602 may cause bits 0 to 15 to be written to registers 721 and 723. A second write to the registers 602 may cause bits 16 to 31 to be written in the registers 723, 726 and 727. A third write to the registers 602 may cause bits 32 to 39 to be written in the register 727, with extra bits being discarded. Together, the registers 721, 723, 725 and 727 may represent a larger unit of data, such as a word, a double word, a frame, or another unit of data comprising more bits than are included in each register 721, 723, 725 or 727. In the embodiment that is depicted, the bits in each register 721, 723, 725 and 727 are numbered to represent 40 bits of related data. Other configurations are possible.

As shown, once 40 bits of data have been stored in the registers 602, the data is further processed by the bit-replicating means 604. The bit-replicating means 604 inputs 10 bits at a time via an input path 716 and outputs 20 bits via an output path 718. Each bit in a block of bits—for example block 721—may be replicated by the bit-replicating means 604, and the bit-replicating means 604 may output a resulting block of replicated bits—for example, to block 722. As shown, “RD0a” and “RD0b” in block 722 represent replicated versions of bit ‘0’ in block 721. Similarly, the bit replicating means 604 may replicate bits from the block 723 to comprise the replicated block of bits 724, bits from block 725 to comprise the replicated block of bits 726, and bits from block 727 to comprise the replicated block of bits 728. Each bit may be replicated twice by the bit-replicating means 604, as shown, or each bit may be replicated a different number of times. For example, by replicating each bit four times, the resulting output bitstream 718 would include bit transitions at one-quarter of the rate of the input bitstream 716.

Referring to FIG. 7B, blocks of encoded bits 708 and 710 and blocks of replicated bits 722, 724, 726 and 728 are further processed and routed in the exemplary embodiment. Selector 614 presents an encoded block of bits 708 or 710 to the serializer 616 by coupling the input path 610 to the output path 730. Alternatively, the selector 614 presents a block of replicated bits 722, 724, 726 or 728 to the serializer 616 by coupling the input path 612 to the output path 730. To be presented to the selector 614, a particular block of bits 722, 724, 726 or 728 is first selected by the block sequencer 606. Each of the blocks 722, 724, 726 and 728 may be selected in turn at a rate at which blocks are presented to the serializer 616 (a “word rate”).

In an exemplary embodiment, the block sequencer 606 is a multiplexer 732 controlled by a counter 734 running at the word rate. As shown in FIG. 7B, the 2-bit counter 734 cycles through the replicated blocks 722, 724, 726 and 728. The counter 734 may run continuously, causing the replicated blocks to be coupled to the serializer in sequence whenever the selector 614 couples the input path 612 to the output path 730.

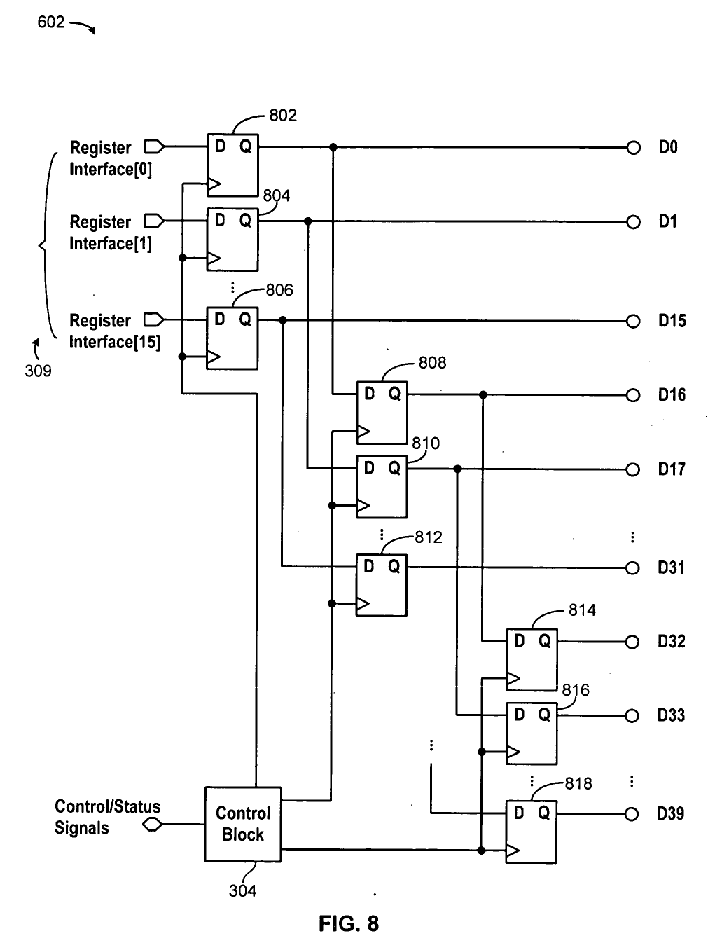

FIG. 8 shows additional details of an exemplary registers 602 that are shown in FIG. 6 and in FIG. 7A. In the exemplary embodiment of the registers 602, a first set of flip-flops 802 to 806 latches data from the register interface 309 during a first write cycle. During a second write cycle, data from the first set of flip-flops 802 to 806 is latched into a second set of flip-flops 808 to 812; new data is then latched from the register interface 309 by the first set of flip-flops 802 to 806. During a third write cycle, data from the second set of flip-flops 808 to 812 is latched into a third set of flip-flops 814 to 818, data from the first set of flip-flops 802 to 806 is latched into the second set of flip-flops 808 to 812, and new data from the register interface 309 is latched into the first series of flip-flops 802 to 806. Depending on the width of the register interface 309 and the number of bits needed, some bits from one or more write cycles may be discarded. For example, as shown in the exemplary embodiment, once three cycles of data have been written to the registers 602, 40 bits of data will be available for further processing on data lines D0 to D39, and eight bits will have been discarded. As shown, the control block 304 controls the timing with which each set of flip-flops latches data.

The registers may have other configurations. For example, the registers 602 may comprise latches or memory elements. The registers 602 may be of any practical or suitable width, and may be configured to be written to more times or fewer times before data is available for processing.

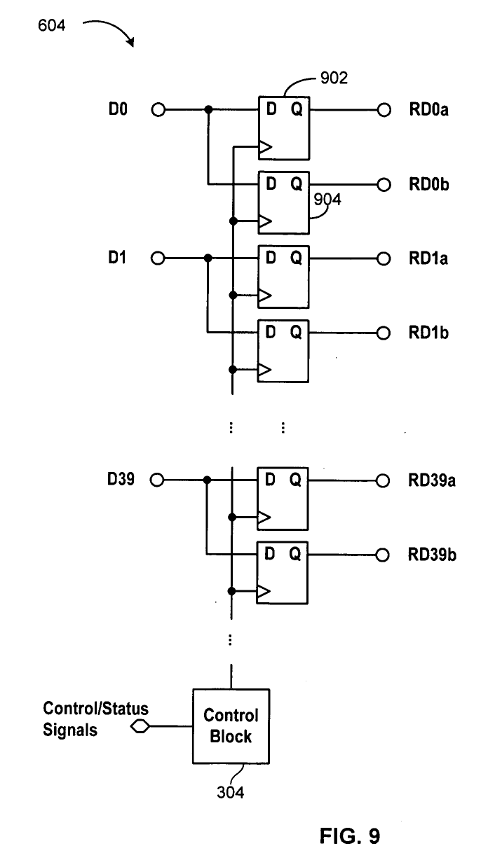

FIG. 9 shows additional details of the exemplary bit-replicating means 604 that is shown in FIG. 6 and in FIG. 7A. The bit-replicating means 604 replicates each data bit from the register block 602 a predetermined number of times. As shown, the exemplary bit replicator replicates each bit twice. For example, a data bit D0 is replicated by flip-flops 902 and 904. After the data bit D0 is latched, its value is available on both line RD0a and RD0b. Similarly, after being latched, the value of data bit D1 is available on lines RD1a and RD1b. A bit replicator may have other configurations. For example, in place of flip-flops, a bit replicator may comprise latches, logic gates, memory elements, or it may use other means to replicate bits. In various other embodiments, bits may be replicated by hardware, software, or firmware, or a combination of hardware, software and firmware.

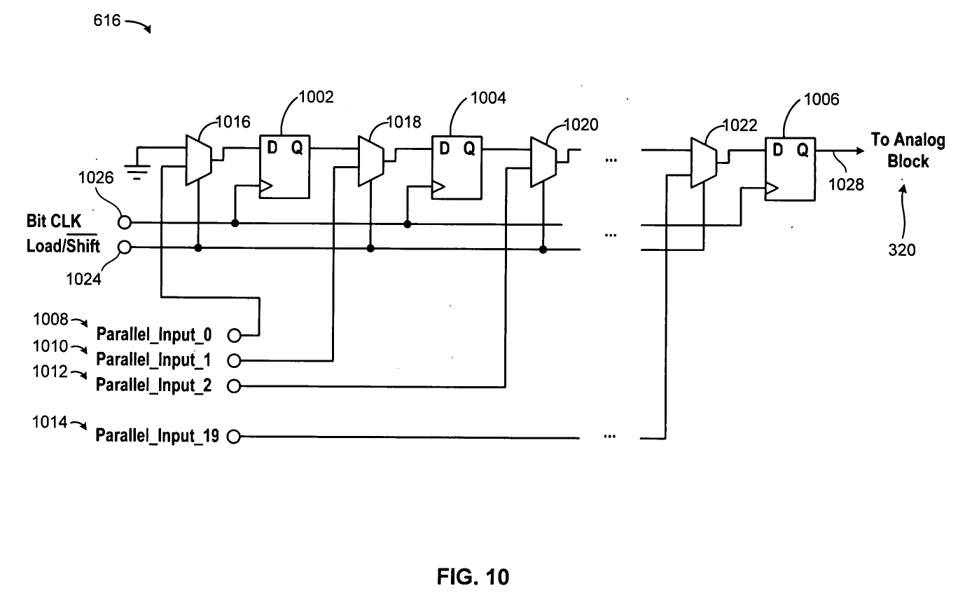

FIG. 10 shows additional details of an exemplary serializer 616 that is shown in FIG. 6. As shown, the exemplary serializer 616 comprises a set of flip-flops configured as a shift register (flip-flops 1002, 1004 and 1006 are shown). The flip-flops are configured to be loaded in parallel through a series of parallel inputs (of which 1008, 1010, 1012 and 1014 are shown). In a shift mode, the input to each flip-flop is selected from the previous flip-flip (or set to logic zero, as in the case of the first flip-flop 1002); in a load mode, the input of each flip-flop is selected from one of the parallel inputs 1008 to 1014. As shown, the selection is made by a series of multiplexers (of which 1016, 1018, 1020 and 1022 are shown) based on the state of a load/shift control signal 1024. Each flip-flop is clocked by a bit clock 1026. With each cycle of the bit clock 1026, one bit of data is shifted to the analog block 320 via output 1028. The load/shift control signal 1024 and the bit clock 1026 may be provided by the control block 304.

Other embodiments capable of serializing bits according to the methods described herein are also possible. For example, latches may be used in place of flip-flops. Bits may be stored in memory elements and shifted by being read from a first set of memory elements and written to a second set of memory elements. In other embodiments, logic gates may be implemented in place of a multiplexer between two digital sources, for example.

A number of embodiments have been described. Nevertheless, it will be understood that various modifications may be made without departing from the spirit and scope of the invention. Accordingly, other embodiments are within the scope of the following claims.

What is claimed is:

1. A method of transmitting data comprising:
transmitting, from a first device to a second device, a first sequence of bits over a serial communications interface at a first transmission rate;
receiving, at the first device from another device, a second sequence of bits;
generating, from the second sequence of bits, a third sequence of bits, wherein the third sequence of bits comprises each bit in the second sequence of bits repeated a predetermined number of times but otherwise arranged in the same order as in the second sequence of bits, such that when the third sequence of bits is transmitted over the serial communication interface at the first transmission rate, the effective transmission rate of the third sequence of bits is a function of the predetermined number of times each bit is repeated; and
transmitting the third sequence of bits from the first device to the second device over the serial communications interface at the first transmission rate.

2. The method of claim 1, wherein the second sequence of bits is associated with an out-of-band (OOB) command.

3. The method of claim 1, wherein the first sequence of bits is associated with data other than an out-of-band (OOB) command.

4. The method of claim 1, wherein the first transmission rate is 3.0 gigabits per second.

5. The method of claim 1, wherein the first transmission rate is 6.0 gigabits per second.

6. The method of claim 1, wherein the effective transmission rate is 1.5 gigabits per second.

7. The method of claim 1, wherein the effective transmission rate is the first transmission rate reduced by a factor corresponding to the predetermined number of times each bit is repeated.

8. The method of claim 8, wherein the predetermined number of times is two.

9. An apparatus comprising a circuit to receive a first sequence of bits and to generate a second sequence of bits, wherein the second sequence of bits comprises each bit in the first sequence of bits repeated a predetermined number of times but otherwise arranged in the same order as in the second sequence of bits, and wherein the first sequence of bits is associated with an out-of-band (OOB) command.

10. The apparatus of claim 9, wherein the second sequence of bits is associated with a serial advanced technology attachment (SATA) bitstream.

11. The apparatus of claim 9, further comprising a serial communication interface that outputs, in a serial bitstream, the second sequence of bits.

12. The apparatus of claim 9, wherein the circuit generates that second sequence of bits at a first bit rate, the second sequence of bits having an effective bit rate that is a function of the predetermined number of times each bit is repeated.

13. The apparatus of claim 12, wherein the first bit rate is 3.0 gigabits per second.

14. The apparatus of claim 12, wherein the effective bit rate is 1.5 gigabits per second.

15. The apparatus of claim 12, wherein the predetermined number of times is three.

16. A controller comprising:
a register interface, that receives a first block of bits to be transmitted serially;
a data interface that receives a second block of bits to be transmitted serially;
a bit-replicator for replicating the received first block of bits, wherein the bit replicator replicates the first block of bits to create a second block of bits that comprises each bit in the first block of bits repeated a predetermined number of times but otherwise arranged in the same order as in the first block of bits; and
an analog interface to output, in a serial bitstream, either the replicated block of bits or the second block of bits.

17. The controller of claim 16, wherein the predetermined number of times is four.

18. The controller of claim 16, wherein the analog interface outputs the replicated block of bits to transmit an out-of-band (OOB) signaling command.

19. The controller of claim 16, wherein the analog interface outputs the second block of bits to transmit serial advanced technology attachment (SATA) data other than out-of-band (OOB) signaling commands.

20. The controller of claim 16, wherein the serial bitstream is output at a rate of 3.0 gigabits per second.
